(19) United States
(12) Patent Application Publication
(10) Pub. No.: US 2020/0365081 A1
(43) Pub. Date: Nov. 19, 2020

(54) TIMING CONTROLLER DEVICE AND A METHOD FOR COMPENSATING AN IMAGE DATA

(71) Applicant: Novatek Microelectronics Corp., Hsinchu (TW)

(72) Inventors: Hua-Gang Chang, Hsinchu County (TW); Chen-Ming Nien, Changhua County (TW)

(73) Assignee: Novatek Microelectronics Corp., Hsinchu (TW)

(21) Appl. No.: 16/414,765

(22) Filed: May 16, 2019

(51) Int. Cl. G09G 3/3225; G06F 1/10

(52) U.S. Cl. CPC G09G 3/3225; G09G 2320/0242; G09G 2310/08; G06F 1/10

(57) ABSTRACT

A timing controller device including a processor device and at least one storage device is provided. The processor device is configured to perform a data counting operation on a first image data according to a first look-up table to obtain a decay factor data and perform a compensation operation on a second image data according to the decay factor data and a second look-up table to obtain the first image data. The at least one storage device is configured to store different parts of the decay factor data. The processor device respectively stores the different parts of the decay factor data to the at least one storage device. A method for compensating an image data is also provided.

### BACKGROUND

### Technical Field

The invention relates to a driving device and a method for processing an image data, specifically, to a timing controller device and a method for compensating an image data.

### Description of Related Art

With the rapid advance and continual progress in technology, the organic light emitting diode (OLED) technology has been provided and widely used in various applications such as TV, computer monitor, notebook computer, mobile phone or PDA. In general, the OLED display includes many OLED pixel circuits arranged in the form of a matrix, and each OLED pixel circuit includes an OLED element and a corresponding driving circuit. However, pixels of the conventional OLED device are controlled by thin-film transistors (TFT). Consequently, the pixels of the conventional OLED device inherit the disadvantages of the TFTs and would be aged along with using time.

“De-burn-in” technology is a compensation method similar to an external compensation for the OLED display. By adjusting an image data, the brightness uniformity of the OLED display panel is achieved. The device decay can be predicted according to a built-in OLED model in the de-burn-in technology. For the same production lines of the same manufacturers, the OLED device property is reproducible. The de-burn-in technology is developed based on the reproducibility of the OLED device property. The image data includes the information that indicates the stress strength of each OLED device. By recording the stress strength as well as the decay property of the OLED device, the de-burn-in technology can be achieved.

However, in the conventional compensation method, too much image data is recorded in a storage device for compensation, such that lifetime and storage space of the storage device become short and small along with using time. In addition, the built-in OLED model is complex for compensation calculation in the conventional compensation method.

### SUMMARY

The invention is directed to a timing controller device and a method for compensating an image data, capable of providing a simple compensation method and increasing lifetime and storage space of a storage device.

An embodiment of the invention provides a timing controller device including a processor device and at least one storage device. The processor device is configured to perform a data counting operation on a first image data according to a first look-up table to obtain a decay factor data and perform a compensation operation on a second image data according to the decay factor data and a second look-up table to obtain the first image data. The at least one storage device is configured to store different parts of the decay factor data. The processor device respectively stores the different parts of the decay factor data to the at least one storage device.

In an embodiment of the invention, the processor device extracts the particular part from the decay factor data according to the common part.

In an embodiment of the invention, the processor device performs the compensation operation on the second image data of a current frame according to the decay factor data of previous frames.

In an embodiment of the invention, the processor device updates the common part stored in the at least one storage device according to the decay factor data of previous frames.

In an embodiment of the invention, the at least one storage device is an embedded dynamic random access memory.

In an embodiment of the invention, the at least one storage device includes a first storage device and a second storage device. The first storage device is configured to store a particular part of the decay factor data. The second storage device is configured to store a common part of the decay factor data. The common part is a minimum value of the decay factor data. The first storage device and the second storage device are separate embedded dynamic random access memories.

In an embodiment of the invention, the first image data is outputted to drive a display panel. The first look-up table and the second look-up table are adjustable for different display panels.

In an embodiment of the invention, the processor device performs the data counting operation on the first image data in a block-based or pixel-based manner.

An embodiment of the invention provides a method for compensating an image data. The method is adapted to a timing controller device and includes: performing a data counting operation on a first image data according to a first look-up table to obtain the decay factor data; performing a compensation operation on a second image data according to the decay factor data and a second look-up table to obtain the first image data; and respectively storing different parts of the decay factor data to at least one storage device.

In an embodiment of the invention, the method further includes extracting the particular part from the decay factor data according to the common part.

In an embodiment of the invention, in the step of performing the compensation operation on the second image data according to the decay factor data and the second look-up table to obtain the first image data, the compensation operation is performed on the second image data of a current frame according to the decay factor data of previous frames.

In an embodiment of the invention, the method further includes updating the common part stored in the at least one storage device according to the decay factor data of previous frames.

In an embodiment of the invention, the at least one storage device is an embedded dynamic random access memory.

In an embodiment of the invention, the at least one storage device comprises a first storage device and a second storage device. The step of respectively storing different parts of the decay factor data to the at least one storage device includes: storing a particular part of the decay factor data in the first storage device; and storing a common part of the decay factor data in the second storage device, wherein the common part is a minimum value of the decay factor data. The first storage device and the second storage device are separate embedded dynamic random access memories.

In an embodiment of the invention, the first image data is outputted to drive a display panel. The first look-up table and the second look-up table are adjustable for different display panels.

In an embodiment of the invention, in the step of performing the data counting operation on the first image data according to the first look-up table to obtain the decay factor data, the data counting operation is performed on the first image data in a block-based or pixel-based manner.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 illustrates a block diagram of a display apparatus according to an embodiment of the invention.

FIG. 2 illustrates a block diagram of the timing controller device depicted in FIG. 1.

FIG. 3 illustrates a block diagram of an image processing module according to an embodiment of the invention.

FIG. 4 illustrates a histogram of a data counting record according to an embodiment of the invention.

FIG. 5 illustrates a trend graph of the first look-up table according to an embodiment of the invention.

FIG. 6 illustrates a schematic diagram of the first look-up table according to another embodiment of the invention.

FIG. 7 illustrates a schematic diagram of the second look-up table according to an embodiment of the invention.

FIG. 8A, FIG. 8B and FIG. 8C illustrate histograms corresponding to the second look-up table depicted in FIG. 7.

FIG. 9 illustrates a flowchart of a method for compensating an image data according to an embodiment of the invention.

### DESCRIPTION OF THE EMBODIMENTS

Embodiments are provided below to describe the disclosure in detail, though the disclosure is not limited to the provided embodiments, and the provided embodiments can be suitably combined. The term “coupling/coupled” used in this specification (including claims) of the application may refer to any direct or indirect connection means. For example, “a first device is coupled to a second device” should be interpreted as “the first device is directly connected to the second device” or “the first device is indirectly connected to the second device through other devices or connection means.” In addition, the term “signal” can refer to a current, a voltage, a charge, a temperature, data, electromagnetic wave or any one or multiple signals.

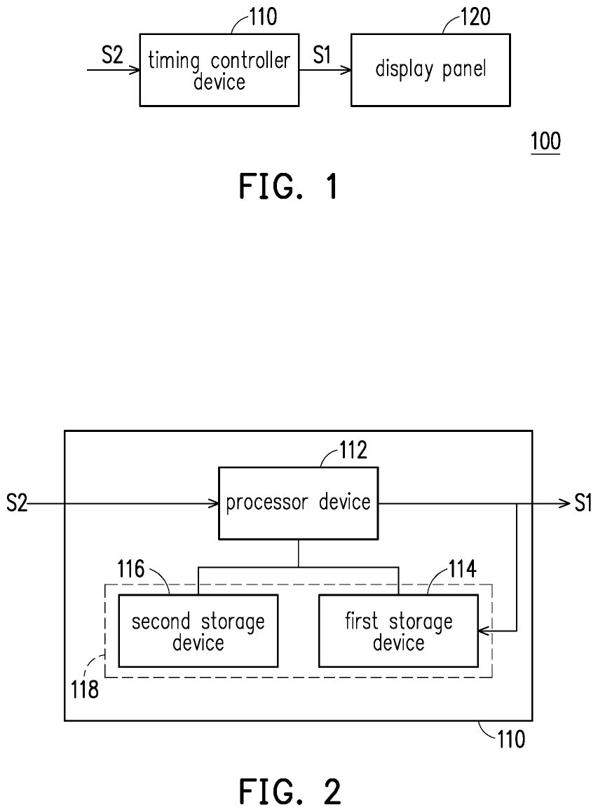

FIG. 1 illustrates a block diagram of a display apparatus according to an embodiment of the invention. Referring to FIG. 1, the display apparatus 100 of the present embodiment includes a timing controller device 110 and a display panel 120. The timing controller device 110 performs a method for compensating a second image data (an original image data) S2 to generate a first image data (a new image data) S1 and drives the display panel 120 according to the first image data S1. In the present embodiment, the display panel 120 may be an organic light-emitting diode (OLED) display panel, and the method for compensating the image data may be a de-burn-in compensation technology for OLED display panels. The invention is not limited thereto. In the de-burn-in compensation technology, the stress of the OLED device may be recorded by a data counting operation, and the image data may be adjusted according to the decay of the OLED device by a compensation operation.

FIG. 2 illustrates a block diagram of the timing controller device depicted in FIG. 1. Referring to FIG. 2, the timing controller device 110 of the present embodiment includes a processor device 112 and at least one storage device 118. The at least one storage device 118 may include a first storage device 114 and a second storage device 116. The processor device 112 is configured to perform the data counting operation on the first image data S1 according to a first look-up table to obtain the decay factor data. In the present embodiment, the decay factor indicates a degradation degree of OLED and may be a product of light-up time and brightness of OLED. The processor device 112 is configured to further perform the compensation operation on the second image data S2 according to the decay factor data and a second look-up table to obtain the first image data. The storage devices 114 and 116 are configured to store different parts of the decay factor data. The processor device 112 respectively stores the different parts of the decay factor data to the storage devices 114 and 116. To be specific, the first storage device 114 is configured to store a particular part of the decay factor data, and the second storage device 116 is configured to store a common part of the decay factor data.

In the present embodiment, the processor device 112 includes, for example, a central processing unit (CPU), a microprocessor, a digital signal processor (DSP), a programmable controller, programmable logic device (PLD), or other similar devices, or a combination of the said devices, which are not particularly limited by the invention. In the present embodiment, the at least one storage device 118 may be a single volatile memory, such as an embedded dynamic random access memory (eDRAM). The eDRAM is a dynamic random-access memory (DRAM) integrated on the same die or multi-chip module (MCM) of an application-specific integrated circuit (ASIC) or a microprocessor. The is to say, the first storage device 114 and the second storage device 116 are the same eDRAM in the present embodiment. In an embodiment, the first storage device 114 and the second storage device 116 are different eDRAMs. In an embodiment, the first storage device 114 and the second storage device 116 are different storage devices. For example, the first storage device 114 is an eDRAM, and the second storage device 116 is a built-in register of the processor device 112 or an external device out of the processor device 112.

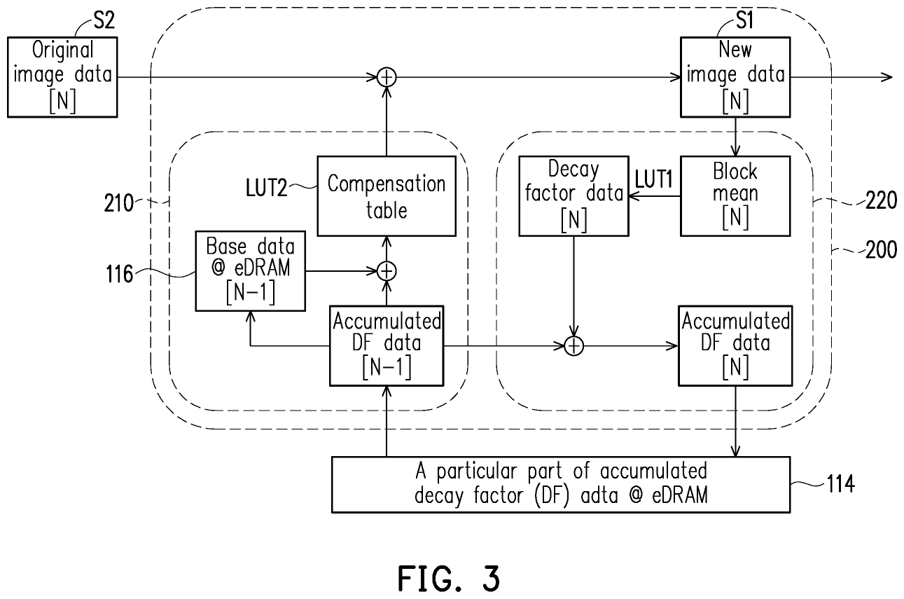

FIG. 3 illustrates a block diagram of an image processing module according to an embodiment of the invention. Referring to FIG. 3, taking a de-burn-in algorithm for example, the image processing module 200 may include a compensation module 210 and a data counting module 220. In the present embodiment, each of the modules may be implemented as a plurality of program codes. These program codes will be stored in a non-transitory computer-readable recording medium, so that these program codes may be executed by the processor device 112. Alternatively, in an embodiment, each of the modules depicted in FIG. 3 may be implemented as one or more circuits. The invention is not intended to limit whether each of the modules is implemented by ways of software or hardware.

In the present embodiment, the processor device 110 performs the data counting operation on the first image data S1 of a current frame [N]. The data counting operation may be performed in a block-based manner or in a pixel-based manner. In the block-based manner, the current frame [N] may be divided into a plurality of blacks, and each block includes a plurality of pixels. The processor device 110 calculates a mean value of each block data in the block mean module. Thus, the processor device 110 may obtain the decay factor data of the current frame [N] according to the mean value of each block data and the first look-up table LUT1. In the pixel-based manner, the block mean module may be omitted, and the processor device 110 obtains the decay factor data of the current frame [N] according to each pixel data and the first look-up table LUT1.

Further, the processor device 110 adds the decay factor data of the current frame [N] and accumulated decay factor data of previous frames [N−1] up to obtain the accumulated decay factor data of the current frame [N]. The accumulated decay factor data may be updated for one or more frames. The processor device 110 stores a part of accumulated decay factor data of the current frame [N] to the first storage device 114, and stores the other part of the accumulated decay factor data to the second storage device 116.

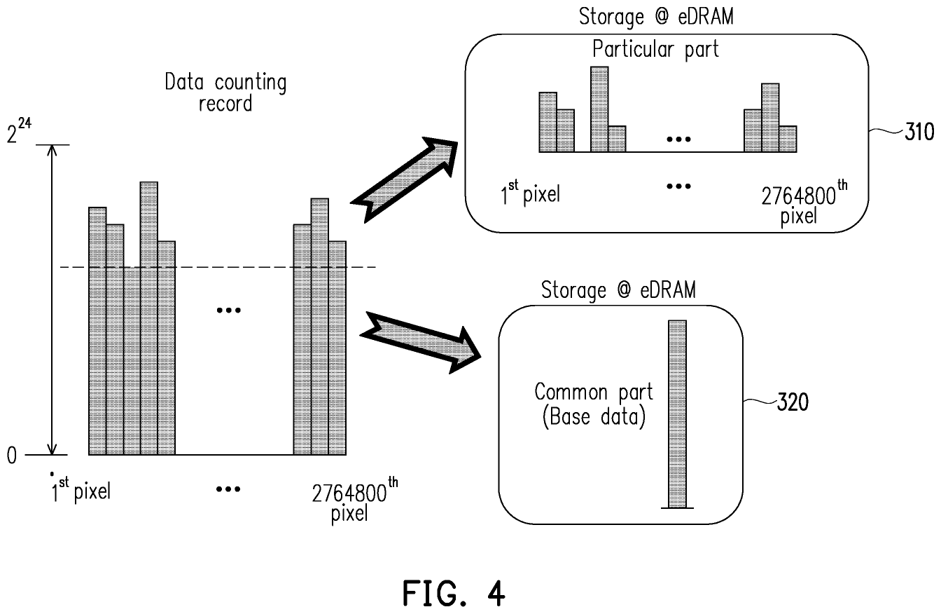

FIG. 4 illustrates a histogram of a data counting record according to an embodiment of the invention. Referring to FIG. 4, the data counting record shows the accumulated decay factor data, which has 2764800 pixels for example. In the present embodiment, the display panel 120 may be have 4K resolution, which refers to a horizontal display resolution of approximately 4,000 pixels. In television, 3840×2160 (4K UHD) is the dominant 4K standard. However, the invention is not intended to limit the resolution of the display panel 120. The processor device 110 extracts a particular part 310 from the accumulated decay factor data according to a common part 320 of the accumulated decay factor. For example, the common part 320 is a minimum value of the accumulated decay factor data and serves as a base data. The processor device 110 subtracts the base data from the accumulated decay factor data to obtain the particular part 310. The processor device 110 stores the particular part 310 to the first storage device 114 and stores the common part 320 of the accumulated decay factor data to the second storage device 116.

In the present embodiment, the first image data S1 and/or the second image data S2 are not stored in the first storage device 114, and the common part 320 is extracted from the accumulated decay factor data. The first storage device 114 stores the particular part 310 of the accumulated decay factor data. Therefore, the size of the data that stored in the first storage device 114 is reduced to increase the storage space and the lifetime of the first storage device 114.

Referring to FIG. 3, the processor device 110 updates the common part 320 stored in the second storage device 112 according to the accumulated decay factor data of the previous frames [N−1] in the compensation module 210. The processor device 110 performs the compensation operation on the second image data S2 of the current frame [N] according to the second look-up table LUT2 and the accumulated decay factor data of previous frames [N−1] to obtain the first image data S1 of the current frame [N]. The compensated first image data S1 of the current frame [N] is outputted to drive the display panel 120 depicted in FIG. 1. In the present embodiment, an OLED model is replaced by the second look-up table LUT2 for image data compensation, and thus the compensation operation becomes more simply by using the second look-up table LUT2.

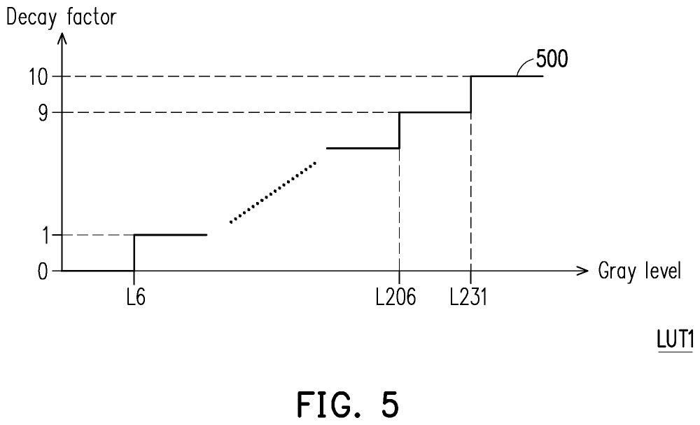

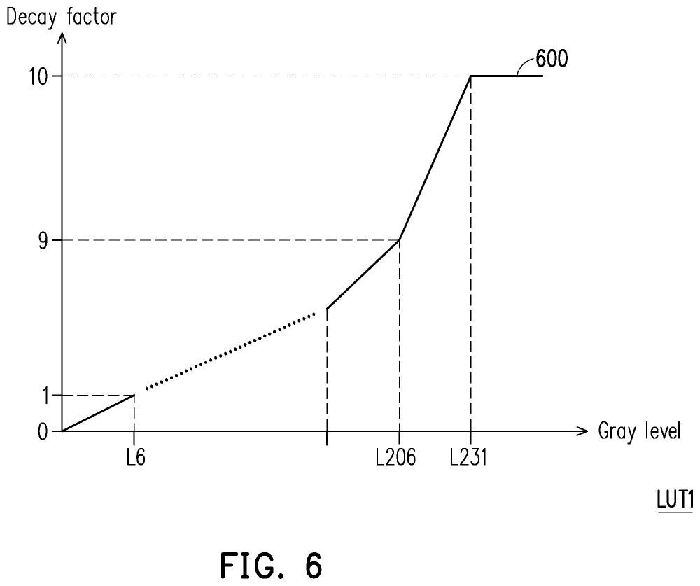

FIG. 5 illustrates a trend graph of the first look-up table according to an embodiment of the invention. Referring to FIG. 5, the step line 500 gradually increases in a stepwise manner from a low gray level to a high gray level. Higher gray levels correspond to larger decay factors. The first look-up table LUT1 depicted in FIG. 5 may be a general table for various OLED types. FIG. 6 illustrates a schematic diagram of the first look-up table according to another embodiment of the invention. Referring to FIG. 6, the polyline 600 also gradually increases from the low gray level to the high gray level. Each segment of the polyline 600 is liner change. The processor device 110 may perform the data counting operation on the first image data S1 according to the first look-up table LUT1 depicted in FIG. 5 or FIG. 6 to obtain the decay factor data. In the embodiments of the invention, the first look-up table LUT1 may be adjustable for various OLED types.

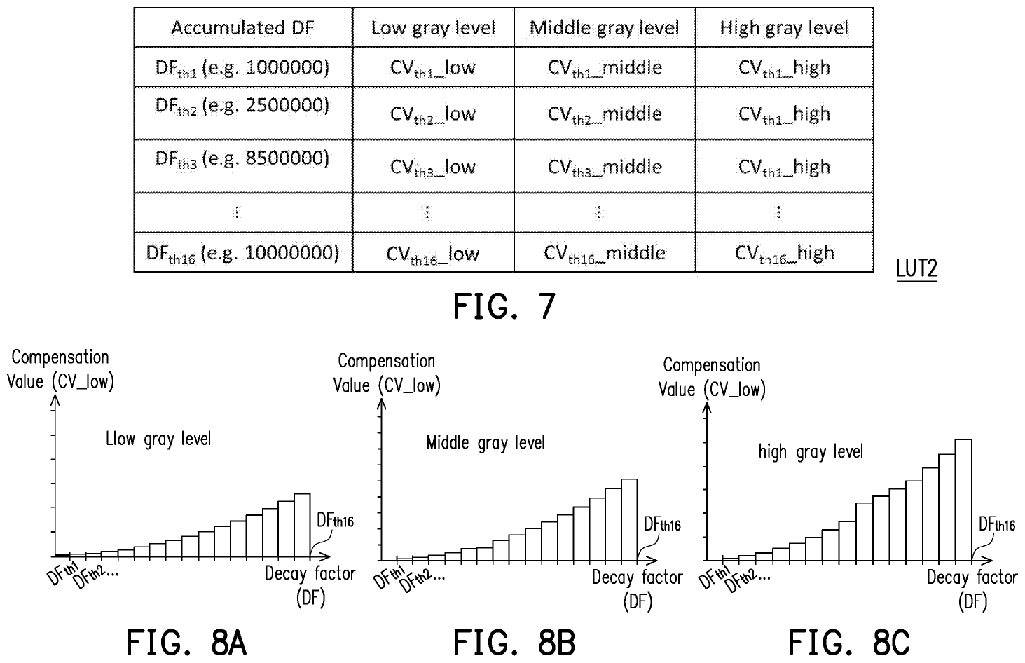

FIG. 7 illustrates a schematic diagram of the second look-up table according to an embodiment of the invention. FIG. 8A, FIG. 8B and FIG. 8C illustrate histograms corresponding to the second look-up table depicted in FIG. 7. Referring to FIG. 7 to FIG. 8C, the second look-up table LUT2 serves as a compensation table and is grouped into three sets, such as a low gray level, a middle gray level and a high gray level, which are illustrated in FIG. 8A, FIG. 8B and FIG. 8C, respectively. The accumulated decay factor data has a plurality of decay factor thresholds DFth1 to DFth16. For each gray level set, different compensation thresholds correspond to different decay factor thresholds DFth1 to DFth16. For example, in the low gray level, the compensation thresholds CVth1 low to CVth16 low correspond to the decay factor thresholds DFth1 to DFth16, respectively. The corresponding relationship of the middle gray level and the high gray level can be deduced by analogy in the second look-up table LUT2. The processor device 110 may perform the compensation operation on the second image data S2 according to the second look-up table LUT2 depicted in FIG. 7 to FIG. 8C to obtain compensation values. In the embodiments of the invention, the second look-up table LUT2 may be adjustable for various OLED types.

In the embodiments of FIG. 5 to FIG. 8C, the gray level is disclosed as an example for the image data, but the invention is not limited thereto. In an embodiment, pixel colors may be analyzed for compensating the image data, and the first look-up table LUT1 and the second look-up table LUT2 may be designed for the pixel colors. In addition, a plurality of first look-up tables LUT1 and second look-up tables LUT2 may be designed for different panel temperatures, such as a low temperature, a room temperature and a high temperature in an embodiment.

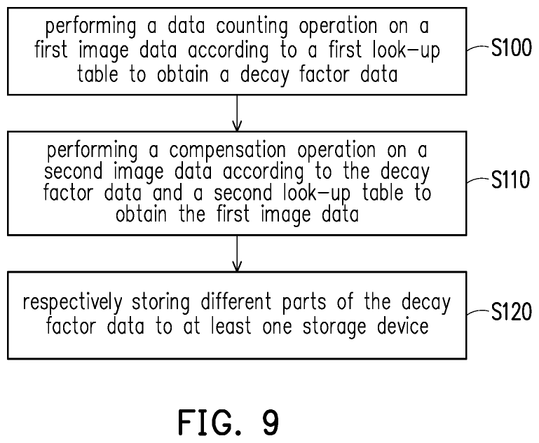

FIG. 9 illustrates a flowchart of a method for compensating an image data according to an embodiment of the invention. Referring to FIG. 2 and FIG. 9, the method for compensating the image data of the embodiment is at least adapted to the timing controller device 110 of FIG. 2, but the invention is not limited thereto. Taking the timing controller device 110 of FIG. 2 for example, in step S100, the processor device 112 performs the data counting operation on the first image data S1 according to the first look-up table LUT1 to obtain the decay factor data. In step S110, the processor device 112 performs the compensation operation on the second image data S2 according to the decay factor data and the second look-up table LUT2 to obtain the first image data S1. The second image data S2 is compensated, and the first image data S1 is outputted to drive the display panel 120. In step S120, the processor device 112 respectively storing different parts 310 and 320 of the decay factor data to at least one storage device 118. In addition, sufficient teaching, suggestion, and implementation illustration regarding the data transmission method of the embodiments of the invention may be obtained from the foregoing embodiments of FIG. 1 to FIG. 8C, and thus related description thereof is not repeated hereinafter.

In summary, in the embodiments of the invention, the first look-up table is used for obtaining the decay factor data from the image data, and the storage device stores a part of the accumulated decay factor data. Thus, the size of the data that stored in the storage device is reduced to increase the storage space and the lifetime of the storage device. In addition, the second look-up table is used the compensation operation for simplifying the calculation. The first look-up table and the second look-up table are adjustable for different display panels. Therefore, the timing controller device can provide a simple compensation method and increase the lifetime and the storage space of the storage device.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A timing controller device, comprising:
a processor device configured to perform a data counting operation on a first image data according to a first look-up table to obtain a decay factor data and perform a compensation operation on a second image data according to the decay factor data and a second look-up table to obtain the first image data; and
at least one storage device configured to store different parts of the decay factor data, wherein the processor device respectively stores the different parts of the decay factor data to the at least one storage device.

2. The timing controller device of claim 1, wherein the processor device extracts the particular part from the decay factor data according to the common part.

3. The timing controller device of claim 1, wherein the processor device performs the compensation operation on the second image data of a current frame according to the decay factor data of previous frames.

4. The timing controller device of claim 1, wherein the processor device updates the common part stored in the at least one storage device according to the decay factor data of previous frames.

5. The timing controller device of claim 1, wherein the at least one storage device is an embedded dynamic random access memory.

6. The timing controller device of claim 1, wherein the at least one storage device comprises:
a first storage device configured to store a particular part of the decay factor data; and
a second storage device configured to store a common part of the decay factor data, wherein the common part is a minimum value of the decay factor data, and the first storage device and the second storage device are separate embedded dynamic random access memories.

7. The timing controller device of claim 1, wherein the first image data is outputted to drive a display panel, and the first look-up table and the second look-up table are adjustable for different display panels.

8. The timing controller device of claim 1, wherein the processor device performs the data counting operation on the first image data in a block-based or pixel-based manner.

9. A method for compensating an image data, adapted to a timing controller device, the method comprising:
performing a data counting operation on a first image data according to a first look-up table to obtain a decay factor data;
performing a compensation operation on a second image data according to the decay factor data and a second look-up table to obtain the first image data; and
respectively storing different parts of the decay factor data to the at least one storage device.

10. The method of claim 9, further comprising:
extracting the particular part from the decay factor data according to the common part.

11. The method of claim 9, wherein in the step of performing the compensation operation on the second image data according to the decay factor data and the second look-up table to obtain the first image data, the compensation operation is performed on the second image data of a current frame according to the decay factor data of previous frames.

12. The method of claim 9, further comprising:
updating the common part stored in the at least one storage device according to the decay factor data of previous frames.

13. The method of claim 9, wherein the at least one storage device is an embedded dynamic random access memory.

14. The method of claim 9, wherein the at least one storage device comprises a first storage device and a second storage device, and the step of respectively storing different parts of the decay factor data to the at least one storage device comprises:
storing a particular part of the decay factor data in the first storage device; and
storing a common part of the decay factor data in the second storage device, wherein the common part is a minimum value of the decay factor data, and the first storage device the second storage device are separate embedded dynamic random access memories.

15. The method of claim 9, wherein the first image data is outputted to drive a display panel, and the first look-up table and the second look-up table are adjustable for different display panels.

16. The method of claim 9, wherein in the step of performing the data counting operation on the first image data according to the first look-up table to obtain the decay factor data, the data counting operation is performed on the first image data in a block-based or pixel-based manner.
